(19) United States
(12) Patent Application Publication
(10) Pub. No.: US 2016/0311447 A1
(43) Pub. Date: Oct. 27, 2016

(54) METHOD FOR LOADING A RAILWAY VEHICLE AND RAILWAY VEHICLE

(71) Applicant: PLASSER & THEURER EXPORT VON BAHNBAUMASCHINEN GESELLSCHAFT M.B.H., Wien (AT)

(72) Inventor: THOMAS BLECHINGER, VIRGINIA BEACH, VA (US)

(21) Appl. No.: 15/105,743

(22) PCT Filed: Jan. 3, 2015
(86) PCT No.: PCT/EP2015/000002

§ 371 Date: Jun. 17, 2016

(30) Foreign Application Priority Data
Jan. 30, 2014 (AT) A 63/2014

(51) Int. Cl. B61D 47/00; B61K 9/02; B65G 67/08; B61D 7/00

(52) U.S. Cl. CPC B61D 47/00; B61D 7/00; B61K 9/02; B65G 67/08; B65G 2814/0326

(57) ABSTRACT

With a bulk material density calculated from the volume Vₛ and the mass mₛ, the maximal dumping height of a dump cone is calculated in relation to a maximal allowable total loading mass mₘₐₓ for a track maintenance vehicle. A movement of the bulk material away from a loading point is controlled automatically for achieving the total loading mass mₘₐₓ which is maximally allowable for the track maintenance vehicle. Thus it is possible to achieve a maximal filling level without exceeding an axle load limit.

The invention relates to a method of loading a track maintenance vehicle with bulk material, wherein the latter after forming a dump cone having a defined bulk material height hₛ—is moved relative to a bulk material container away from a loading point in a transport—or longitudinal direction of the vehicle and a new dump cone is formed. The invention also relates to a track maintenance vehicle.

According to EP 0 429 713 or U.S. Pat. No. 7,192,238, a track maintenance vehicle is already known which, during working operations, can be coupled to any number of similar vehicles to form a loading train. In the rear region of the bulk material container of each track maintenance vehicle, with respect to a transport direction of the conveyor belts, a sensor device is arranged which is designed as a light barrier or as a mechanical feeler and which, during the storage procedure, monitors the completion of a maximal filling height.

For the purpose of determining a payload mass, it is known from DE 20 2013 102 362 to arrange strain gauges on a bogie.

It is the object of the present invention to provide a method of the kind mentioned at the beginning as well as a track maintenance vehicle with which an optimal loading operation is possible.

According to the invention, this object is achieved with a method or a track maintenance vehicle of the specified type by way of the features cited in the characterizing part of claim 1 and 4 or 7.

With a method or a track maintenance vehicle of this kind, it is possible in a particularly economical manner to achieve a maximal filling in each case in dependence on a bulk material density prevailing during the loading operation. In doing so, it is always ensured that a maximal allowable load limit is not exceeded by the payload.

Additional advantages of the invention become apparent from the further claims and the drawing description.

The invention will be described in more detail below with reference to embodiments represented in the drawing.

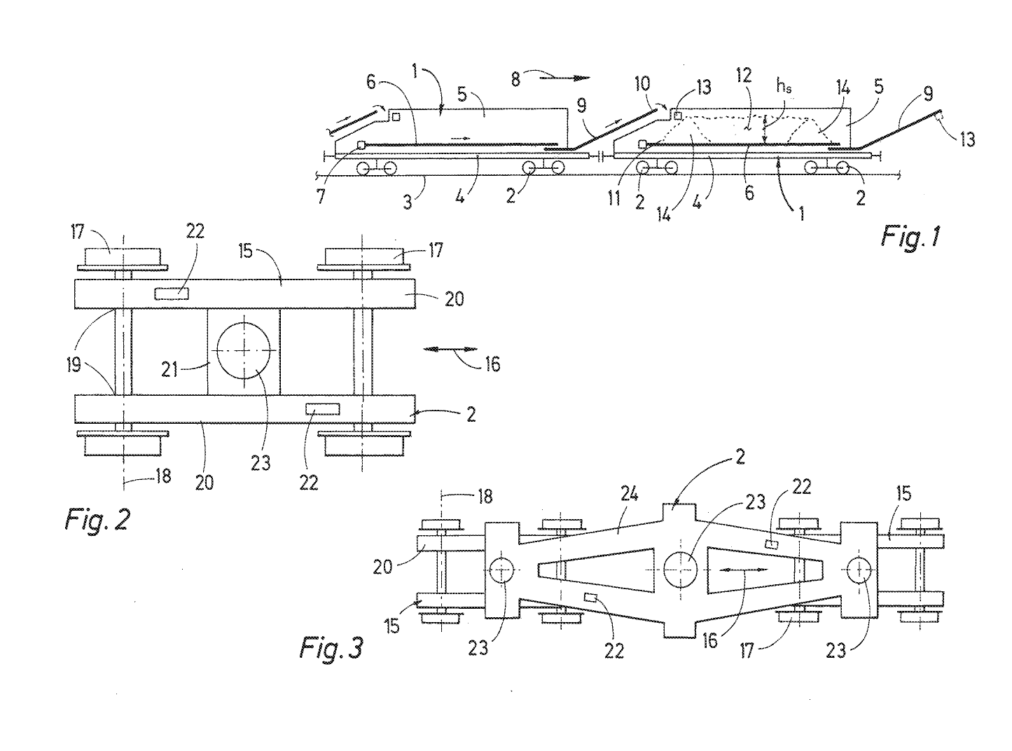

FIG. 1 shows a side view of a loading train composed of two track maintenance vehicles,

FIGS. 2 and 3 each show an enlarged and simplified top view of an on-track undercarriage of the track maintenance vehicle.

Track maintenance vehicles 1, shown FIG. 1, each essentially consist of a vehicle frame 4—mobile via two on-track undercarriages 2 on a track 3—and a bulk material container 5 connected to the same. A bottom conveyor belt 6 extending in the longitudinal direction of the wagon forms the bottom surface of the bulk material container 5 and has a drive 7 for movement of the belt in a transporting direction 8. Provided at the front end, with regard to said transporting direction 8, of the bulk material container 5 is a transfer conveyor belt 9 which is supported on the wagon frame 4 underneath a discharge end of the bottom conveyor belt 6, adjoining the same. The transfer conveyor belt 9 is designed leading upward at a slant, projecting beyond a front end of the wagon frame 4, and is equipped with a drive.

By means of coupling devices, any number of similarly designed track maintenance vehicles 1 can be assembled to form a loading train mobile on the track 3 and able to self-load and -unload. In doing so, bulk material 12 discharged from a transfer point 10 onto a loading point 11 of the bottom conveyor belt 6 is stored. In the region of the transfer point 10, a non-contact sensor device 13 is provided which serves for continuous detection of a bulk material height hₛ and of the volume of a dump cone 14 forming in the area of the loading point 11.

The on-track undercarriage 2 shown enlarged and simplified in FIG. 2 has a bogie frame 15 provided for mounting two wheel sets 17 spaced from one another in a longitudinal direction 16. Said bogie frame 15 is composed of two longitudinal frame beams 20 which are spaced from one another with regard to an axis of rotation 18 of the wheel sets 17 and each have an axle bearing 19 for supporting a wheel set 17. These longitudinal frame beams 20 are connected to one another midway between the two wheel sets 17 by a transverse frame beam 21.

A strain gauge 22 is arranged on each longitudinal frame beam 20 in each case between the transverse frame beam 21 and the axle bearing 19 of the adjoining wheel set 17. However, only a single strain gauge 22 is provided on each longitudinal frame beam 20, with the two strain gauges 22 being positioned offset to one another as seen in a transverse direction extending parallel to the axis of rotation 18. The signals of the two strain gauges 22 are combined in a measuring amplifier in order to arrive at a mean value of the strain. Preferably, the strain gauges 22 are fastened to the underside of each longitudinal frame beam 20. A swivel ring 23 or a bogie pivot for connection to the vehicle frame 4 is provided centrally on the transverse frame beam 21.

Each strain gauge 22 is fastened at a point of the longitudinal frame beam 20 at which a main power flow with tension lines running parallel to one another is present in which the shear stresses become zero, the main power flow extending in the longitudinal direction 16 of the longitudinal frame beam 20 and having a minimum of transversely extending force reactions. This means that the power flow direction runs unambiguously in only one direction, without “interfering” (shear) power influences from other directions which would influence the measuring result of the strain gauge 22.

The best possible positioning of the strain gauge 22 is determined for each individual on-track undercarriage 2 by means of the finite elements method. This guarantees, on the one hand, the correct positioning and, on the other hand, a maximum of precision.

In FIG. 3, a variant of an on-track undercarriage 2 is depicted which is suited for particularly heavy loads. This undercarriage 2 is composed of two bogie frames 15 of the type already described in FIG. 2, which are spaced from one another in the longitudinal direction 16. Both bogie frames 15 are articulatedly connected by means of a bogie pivot 23 to a frame bridge 24 which, for connection to the vehicle frame 4, has a central swivel ring 23 positioned between the bogie pivots 23 of the bogie frames 15.

A respective strain gauge 22 is arranged on the frame bridge 24 in each case between the central swivel ring 23 thereof and the adjacent bogie pivot 23 of the adjoining bogie frame 15. A total of only two strain gauges 22 are arranged on the frame bridge, wherein these are positioned offset to one another as seen in a transverse direction extending parallel to the axis of rotation 18. As a result of this offset of the strain gauges 22, it is possible to compensate the tilt of the vehicle in the case of a track super elevation.

Within the scope of the method according to the invention, it is in principle also possible—for the purpose of determining the loading mass—to detect the load-caused force effect on the on-track undercarriage 2 also by means of other known methods, for example by measuring the spring compression or by arranging strain gauges on the bogie suspension.

The method according to the invention will now be described in more detail, particularly in connection with FIG. 1. The front track maintenance vehicle 1, with regard to the transporting direction 8, is in a state of being loaded in that the bottom conveyor belt 6 is not moved. Via the transfer conveyor belt 9, adjoining the rear end, of the adjoining rear track maintenance vehicle 1, bulk material is discharged, resulting in a consistently growing dump cone 14.

The volume Vₛ of the dump cone 14 is calculated via constant detection of the bulk material height hₛ by the sensor device 13. In order to compensate asymmetrical loading, for instance in track super elevations, it is advantageous to employ two sensor devices spaced from one another in the transverse direction of the vehicle, which alternatively could also be positioned at the upper end of the transfer conveyor belt 9.

Parallel thereto, a force effect caused by the loading is measured at the on-track undercarriage 2 supporting the track maintenance vehicle 1, and with this the mass mₛ of the dump cone 14 is calculated.

With a bulk material density computed from the volume Vₛ and the mass ms, the maximal dumping height or the maximum degree of filling hₓ of the dump cone 14 is computed in relation to a maximal allowable total loading mass mₘₐₓ for the track maintenance vehicle 1. As soon as the maximal dumping height is reached, the drive of the bottom conveyor belt 6 is automatically activated, causing the bulk material cone 14 to be moved forward in the transport direction 8 relative to the bulk material container 5, away from the loading point 11.

This process is repeated until the original first dump cone 14 has reached the front end of the bottom conveyor belt 6. This step-wise motion of the bottom conveyor belt 6 is controlled automatically in such a way that, with the complete loading of the bulk material container 5, the maximal allowable total loading mass mₘₐₓ is reached.

Thus, the loading capacity can be utilized in an optimal way, without an impermissible transgression of the axle load or a damaging overloading of the track maintenance vehicle taking place in the process. Additionally, an optimal distribution of the stored bulk material over the entire length of the bulk material container 5 can thus be ensured.

The achieving of the maximal allowable loading is indicated to the operator optically and acoustically at the track maintenance vehicle 1. In the case of overloading, it is additionally possible—with the aid of a telematics module mounted fixedly on the vehicle—to automatically send a text message to one or more previously defined telephone numbers. By means of GPS receivers integrated into each vehicle, the working direction of the vehicle can be determined; it is also possible to link the actual loading mass as well as any possible transgressions unambiguously to a location determined by GPS.

1-8. (canceled)

9. A method of loading a track maintenance vehicle with bulk material, which comprises:
forming a dump cone at a loading point, the dump cone having a defined bulk material height hₛ;
subsequently moving the dump cone relative to a bulk material container away from the loading point in a transport direction of the vehicle and forming a new dump cone;
calculating a volume Vₛ of the dump cone formed at the loading point with the aid of the bulk material height hₛ;
measuring an effect of a force caused by loading the dump cone at an on-track undercarriage supporting the track maintenance vehicle and calculating therefrom a mass mₛ of the dump cone;
calculating a bulk material density from the volume Vₛ and the mass mₛ, and calculating therefrom a maximal dumping height of the dump cone in relation to a maximal allowable total loading mass mₘₐₓ for the track maintenance vehicle, and optionally indicating to an operator and/or automatically controlling a movement of the dump cone away from the loading point for achieving the maximal allowable total loading mass mₘₐₓ.

10. The method according to claim 9, which comprises, after reaching the maximal allowable loading mass mₘₐₓ, automatically stopping a onward movement of the bulk material and the loading operation.

11. The method according to claim 9, wherein the measuring step comprises measuring a deflection in the on-track undercarriage and deducing therefrom the mass mₛ of the dump cone.

12. A track maintenance vehicle, comprising:
a vehicle frame supported on on-track undercarriages, each said on-track undercarriage having the following features:
a bogie frame supporting two wheel sets spaced apart from one another in a longitudinal direction;
said bogie frame being formed with two longitudinal frame beams that are spaced from one another with regard to an axis of rotation of the wheel sets and each having an axle bearing for supporting a respective said wheel set;
a transverse frame beam connecting said two longitudinal frame beams to one another between said two wheel sets;
strain gauges for detecting a frame deflection mounted to said bogie frame, wherein a respective strain gauge is arranged on each longitudinal frame beam between said transverse frame beam and said axle bearing of the adjoining said wheel set in each case.

13. The track maintenance vehicle according to claim 12, wherein only a single said strain gauge is provided on each said longitudinal frame beam, and wherein two said strain gauges are positioned offset to one another in a transverse direction extending parallel to the axis of rotation.

14. The track maintenance vehicle according to claim 12, wherein said strain gauge is fastened at a point of said longitudinal frame beam at which a main power flow is present that extends in the longitudinal direction of said longitudinal frame beam and has a minimum of transversely extending force reactions.

15. A track maintenance vehicle, comprising:
a vehicle frame supported on on-track undercarriages, each said on-track undercarriage having the following features:
a bogie frame supporting two wheel sets spaced apart from one another in a longitudinal direction;
said bogie frame being formed with two longitudinal frame beams that are spaced from one another with regard to an axis of rotation of the wheel sets and each having an axle bearing for supporting a respective said wheel set;
a transverse frame beam connecting said two longitudinal frame beams to one another between said two wheel sets;
a bogie pivot connecting each of two bogie frames that are spaced from one another with regard to the longitudinal direction to a frame bridge which has a central swivel ring, positioned between said bogie pivots of said bogie frames, for connection to said vehicle frame; and
strain gauges for detecting a frame deflection respectively mounted to said frame bridge between said central swivel ring and an adjacent said bogie pivot of an adjoining said bogie frame.

16. The track maintenance vehicle according to claim 15, wherein only two strain gauges are arranged on said frame bridge, wherein said two strain gauges are positioned offset to one another as seen in a transverse direction extending parallel to the axis of rotation.
